(19) United States
(12) Patent Application Publication
(10) Pub. No.: US 2004/0177094 A1
(43) Pub. Date: Sep. 9, 2004

(54) Association of application specific code with nodes of a document object model using extensions to an XML schema

(75) Inventors: Nigel Jacobs, Austin, TX (US); Christine Tomlinson, Austin, TX (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/382,414

(22) Filed: Mar. 6, 2003

(51) Int. Cl. G06F 17/00

(52) U.S. Cl. 707/104.1

(57) ABSTRACT

Techniques have been developed to encode in an XML schema element an identification of a class that implements the element. Using an XML schema encode in this way, a parser may perform (at parse time) application-specific modifications to an active document object model (DOM) tree. Linking the specification of application-specific processing to the schema provides significant maintenance advantages. Furthermore, the technique allows provision of a scripting facility. Two suitable XML facilities that may be used to encode the extensions are (1) attributes in a name space declared in the schema and (2) annotations. A computer readable encoding of an XML schema element, the encoding including an extension mechanism that identifies a class that implements the element.

### BACKGROUND

1. Field of the Invention

The present invention relates to functionally-descriptive encodings of information and, in particular, to encodings that facilitate a platform- and language-neutral interface that allows programs and scripts to dynamically access and update the content, structure and/or style of documents or other information.

2. Description of the Related Art

Markup language technologies, including those commonly associated with HyperText Markup Language (HTML), Standard Generalized Markup Language (SGML) and eXtensible Markup Language (XML) have long been employed in software systems to enhance platform-, language- and/or vendor-independent encoding of data. In particular, XML technologies, including protocols, syntax, schemas, data type definitions, query facilities, style sheets, document object model interfaces, and other technologies, have become the framework of choice for representing structured documents and data on the Web. Much of the technology development in this area is summarized in documentation, standards and/or recommendations available from the World-Wide Web Consortium (W3C). See e.g., materials cataloged at http://www.w3.org/XML/.

### SUMMARY

It has been discovered that some benefits of markup language technologies can be enhanced using techniques that encode in a schema, an extension construct that maps an element of the schema to functionality (e.g., an abstract class) that implements the element. Using such techniques, application specific customizations of a markup language processing environment can be encoded in a schema representation for the markup language processing environment. By doing so, maintainability of a customized markup language processing environment is generally enhanced. Typically, customizations of a general processing environment (e.g., parser) can be specified (or referenced) using structured data, rather than through modifications to the structure and operation of the processing environment, itself.

In some embodiments of the present invention, a method of supporting application specific functionality in an XML processing environment includes encoding in an XML schema, an extension construct that maps an element of the XML schema to a class that implements the element. In some variations, the method further includes providing in conjunction with a parser, a mechanism to instantiate in the XML processing environment, the mapped class. In some variations, the extension construct employs an attribute in a namespace of the XML schema or annotations of the XML schema.

In other embodiments in accordance with the present invention, a schema is encoded in one or more computer readable media. The schema encoding includes plural tagged markup language encoded elements, wherein at least one of the tagged markup language encoded elements is extended by a mechanism that maps an element of the schema to a class that implements the element. In some variations, the tagged markup language is in accordance with an XML syntax. In some variations, the extension construct employs an attribute in a namespace of the schema.

In still other embodiments in accordance with the present invention, a tagged markup language processor instantiates functionality in an execution environment based on a schema extended by a mechanism that maps an element of the schema to the functionality, the functionality implementing the element, and the tagged markup language processor evaluates tagged markup language directives at least in part using the instantiated functionality.

In still yet another embodiment in accordance with the present invention, a tagged markup language processor includes a schema encoded in media readable by the tagged markup language processor; and a parser that instantiates functionality in an execution environment based on elements of the schema, wherein the schema is extended by a mechanism that maps at least a particular element thereof to the functionality, and wherein the mapped functionality implements the particular element.

In still yet another embodiment in accordance with the present invention, an apparatus includes means for encoding a schema extended by a mechanism that maps an element of the schema to functionality that implements the element and means for evaluating a directive based at least in part on the functionality.

### BRIEF DESCRIPTION OF THE DRAWINGS

The present invention may be better understood, and its numerous objects, features, and advantages made apparent to those skilled in the art by referencing the accompanying drawings.

FIG. 1 depicts an XML-oriented environment in which techniques of the present invention are employed to encode in schema, an extension construct that maps an element of the schema to functionality (e.g., an abstract class) that implements the element.

FIG. 2 illustrates a flow for an extension construct recognition process.

FIG. 3 illustrates a flow for a sequence that walks a parsed representation of XML elements and invokes corresponding instantiated classes.

The use of the same reference symbols in different drawings indicates similar or identical items.

### DESCRIPTION OF THE PREFERRED EMBODIMENT(S)

Although techniques of the present invention are not limited to exploitations in accordance with an eXtensible Markup Language (XML) syntax, or any particular variant thereof, certain aspects may be understood in the context of current XML technologies and terminology. Accordingly, certain illustrative realizations are described using current XML technologies and terminology to facilitate understanding by persons of ordinary skill in the art. However, based on the description herein, persons of ordinary skill in the art will appreciate implementations and exploitations suitable for other structured information encodings including other markup language contexts now or hereafter developed. In view of the above, and without limitation, XML-oriented embodiments are now described.

As described herein, an XML schema element may be extended to include an identification of particular functionality (e.g., functionality encoded as an abstract class) that implements the element. Using an XML schema encoded in this way, language processor, e.g., a parser, may perform (e.g., at parse time) application-specific modifications to an active document object model (DOM) tree or other representations of information corresponding to XML encoded data. Linking the specification of application-specific processing to the schema can provide significant maintenance advantages. For example, application-specific modification need not be made to the processing environment itself, e.g., such modifications need not be made to a parser. Instead, customizations can be represented in the schema by reference to the implementing code. In some exploitations, the techniques facilitate provision of a scripting facility. In general, two suitable XML facilities that may be used to encode the extensions are (1) attributes in a name space declared in the schema and (2) annotations. While some exploitations of the present invention include language processors and/or gateway embodiments, others include functionally descriptive encodings of schemas themselves. These and other embodiments will be understood based on the description that follows and based on the appended claims.

In accordance with some embodiments of the present invention, we have developed and employ an XML schema encoding that employs a predefined form to identify an encoded mapping of an element of the schema to a particular representation of functionality that implements the element. The element is typically identified in the XML schema using an identifying name together with an identifier (e.g., a URI) for the implementing functionality. For example, in some exploitations, an appropriate encoding is as follows:

```
...
<xsd:element name=“set” xxsd:class=“com.sun.xxs.base.tags.Set”>
  <xsd:complexType>
    <xsd:attribute name=“ref” use=“required”
      xxsd:type=“reference”/>
    <xsd:attribute name=“mode” default=“text”/>
    <xsd:attribute name=“preserve” type=“booleanChoice”
      default=“no”/>
    <xsd:attribute name=“value” use=“required”/>
  </xsd:complexType>
</xsd:element>
...
```

where an element named “set” of the schema has an associated class that implements the corresponding functionality, and which can be found using the URI-style identifier “com.sun.xxs.base.tags.Set”. In the illustrated encoding, the implementing class is identified using an xxsd: class tag(s), which would be recognized by a parser or other environment that processes the schema. Note that the xxsd: type tag(s) signal(s) that attribute “ref” of the element encodes a reference (i.e., to the location to be set). Other elements may include tags that indicate that a particular attribute encodes (or returns) a value. In this way, the XML schema element encodes that attributes are passed by reference or value (as the case may be). Other tags, other identification or referencing constructs and/or other type specifying constructs are also suitable and may be employed in other realizations.

The XML schema element establishes that the implementing class (com.sun.xxs.base.tags.Set) expects two required attributes, named ref and value, as well as a mode and preserve behavior attribute. Accordingly, a software object implementing a set method expects to receive both an identification of the location or element to be set and the value to which the location or element is to be set. While the set functionality is relatively simple, persons of ordinary skill in the art will recognize that complex behaviors and/or functionality may be similarly implemented.

For example, another appropriate XML schema encoding is as follows:

Indeed, in some exploitations, implemented behaviors may be more akin to scripting language elements or operators than functions or procedure calls.

```
...
  <xsd:element name=“loop” xxsd:class=“com.sun.xxs.base.tags.Loop“>
    <xsd:complexType>
      <xsd:attribute name=“inc” default=“1”/>
      <xsd:attribute name=“limit”/>
      <xsd:attribute name=“ref” default=“loop”
        xxsd: type=“reference”/>
      <xsd:attribute name=“start” default=“0”/>
    </xsd:complexType>
  </xsd:element>
...
```

where an element named “loop” of the schema has an associated class that implements the corresponding functionality, and which can be found using the identifier “com.sun.xxs.base.tags.Loop”. As before, the implementing class is identified using an xxsd: class tag(s), which would be recognized by a parser or other environment that processes the schema. Note that an xxsd: type tag(s) signals that attribute “ref” of the element (e.g., a logical name associated with an instance of the loop) is passed by a reference. A wide variety of program control elements, or constructs (e.g., predicate tests, while, for, branch, etc.) may be similarly implemented. In some realizations, a scripting facility is supported using such element or constructs.

In each case, the XML schema defines structural aspects of the use and/or interaction with functionality of the implementing class, while allowing the implementing class to be separately maintained. In some exploitations, a class may be implemented differently for different application- or environment-specific purposes. In some exploitations, revisions to the associated functionality are facilitated, either through modifications to the underlying class identified by a particular XML schema element or by revising the XML schema element definition to identify a new class. Some exploitations may employ XML schema extension constructs to support a scripting language.

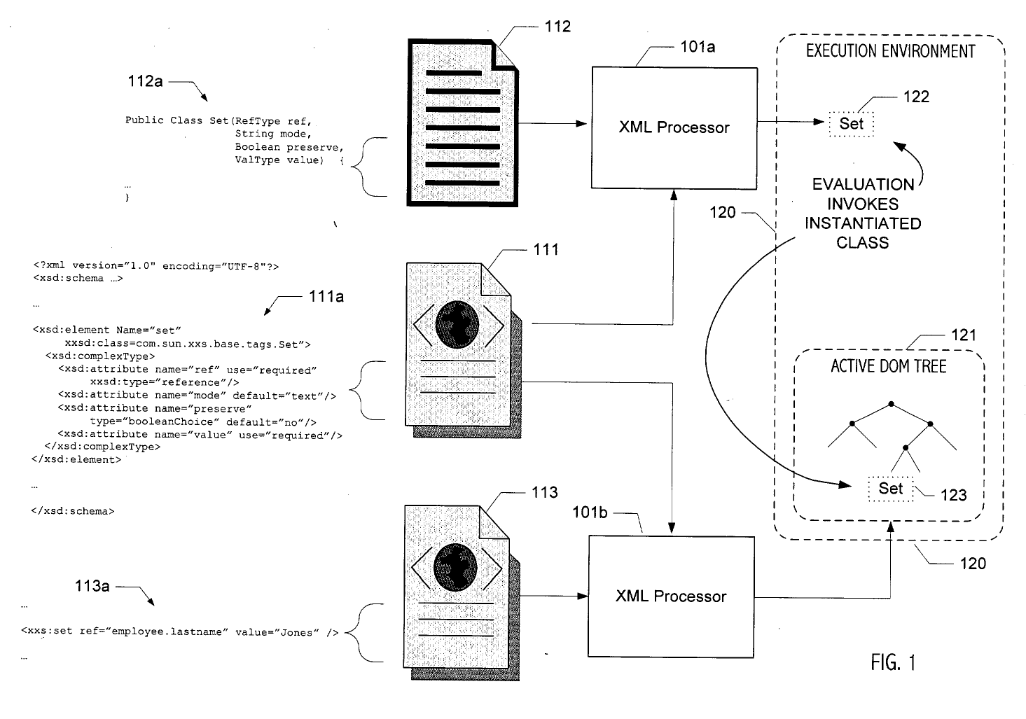

FIG. 1 depicts an XML-oriented environment in which techniques of the present invention are employed to encode in a schema, an extension construct that maps an element of the schema to functionality (e.g., an abstract class) that implements the element. In particular, FIG. 1 illustrates an XML processor 101a that parses XML schema 111 and recognizes therein XML schema element definitions (such as element 111a) that are extended to identify corresponding classes that implement the elements. In the illustrated configuration, XML processor 101a also sets up a mapping of the extended element to the corresponding class (e.g., class 112a encoded in code module 112) and instantiates the class in an execution environment 120. In this way, the execution environment representation of XML schema 111 is extended (e.g., to provide application specific functionality) using the functionality defined by class 112a.

Although a variety of execution environments and in memory representations may be employed, one suitable representation is as an active Document Object Model (DOM) representation, e.g., active DOM tree 121. In general, a Document Object Model is a platform- and language-neutral interface that allows programs and scripts to dynamically access and update the content, structure and style of documents. The document can be further processed and the results of that processing can be incorporated back into the presented page or document. DOM representations, implementations, application programming interfaces (APIs) are all well known in the art. Indeed, Document Object Models are the subject of ongoing activity by the World Wide Web Consortium (W3C). Current efforts are summarized and specification information is included, in the “Document Object Model (DOM) Level 3 Core Specification,” Version 1.0, W3C Working Draft 22 Oct. 2002, which can be found at http://www.w3.org/TR/2002/WD-DOM-Level-3-Core20021022/DOM3-Core.pdf. Descriptions herein will be understood by persons of ordinary skill in the art in the context of terminology, implementations, standards, mark-up language constructs and generalized computing infrastructure and software tools typical of the Document Object Model (DOM) efforts. Some DOMs are well understood and both specifications and implementations are widely available that material is not duplicated here.

Although a variety of implementations are contemplated and possible for XML processor 101a, some exemplary implementations build upon SAX (Simple API for XML) parser implementations. In general, SAX parsers represent a well-known body of work and implementations are generally available to persons of ordinary skill in the art, typically in open source form. See generally, materials at http://www.saxproject.org/ for a listing of SAX and/or SAX-inspired parsers, including implementations available from a variety of vendors/contributors (such as the Gnu Project, Apache, Oracle, Source Forge and Sun Microsystems, Inc.). For clarity, much of the description herein of exemplary implementation builds on terminology and facilities typical of the SAX parser implementations available from Sun Microsystems, Inc. in its JAXP 1.1 API, which is well recognized by persons of ordinary skill in the art and available for download as source code with documentation from http://java.sun.com/xml/download.html. Since parser technologies including SAX parser technologies are well understood and both specifications and implementations are widely available that material is not duplicated herein. However, based on the description herein, persons of ordinary skill in the art will appreciate applications and exploitations of the inventive techniques described herein using other parser implementations, indeed other markup language processors.

Building on a SAX parser environment such as that provided by/with the JAXP 1.1 API, XML processor 101a will be better understood as follows. A DOMImplementation instance includes, as part of its initialization, an invocation of a loadSchema method that loads XML Schema 111 by invoking the SAX parser. Eventually, an extractXXSInfo call is made on an instance of XSDElement created by operation of the SAX parser. An exemplary implementation of class XSDElement follows:

```
public class XSDElement extends XSDTag {
  public String getXSDType( ) {
    return DOMImplementation.OBJ_TYPE_EL;
  }
  public void extractXXSInfo(DOMImplementation domImpl,
                          XSDTag parent) {
    this.parent = parent;
    String xxsName = getXxsName( );
    if (xxsName != null) {
      Attr classAttr =
        (Attr) attrs.getNamedItemNs(domImpl.xxsdURI, “class”);
      if (classAttr != null) {
        domImpl.setObjectClassName(getTargetNamespace( ),
                                  xxsName,
                                  classAttr.getValue( ),
                                  getXSDType( ));
      }
      Attr typeAttr =
        (Attr) attrs.getNamedItemNS(getNamespaceURI( ), “type”);
      if (typeAttr != null)
        domImpl.setElementType(getTargetNamespace( ),
                              xxsName,
                              typeAttr.getValue( ));
    }
    org.w3c.dom.NodeList children = getChildNodes( );
    for (int i = 0; i < children.getLength( ); i++) {
      org.w3c.dom.Node child = item(i);
      if (child instanceof XSDTag)
    ((XSDTag) child).extractXXSInfo(domImpl, this);
    }
  }
  public String getTypeName( ) { return “XSDELM”; }
}
```

where the class name of an XXS sub-language element is set using the following exemplary implementation of setObjectClassName:

```
public void setObjectClassName(String namespaceURI,
                            String elementName,
                            String className,
                            String xsdObjType) {
  if (xsdObjType == OBJ_TYPE_EL) {
    elementClassNames.put(namespaceURI, elementName, className);
  } else {
    typeClassNames.put(namespaceURI, elementName, className);
  }
}
```

to record the mapping of an XXS element of XML Schema 111 (e.g., element 111a) to the corresponding Java class (e.g., class 112a). In this way, XML processor 101a instantiates, in execution environment 120, a class (e.g., Public Class Set) that implements the corresponding element (e.g., <xsd:element Name=“Set” . . . >) of XML Schema 111. Other markup languages, processors and execution environments may appropriately vary the above implementations to conform to their particulars and/or design goals without departing from the spirit and scope of the inventive concepts described herein.

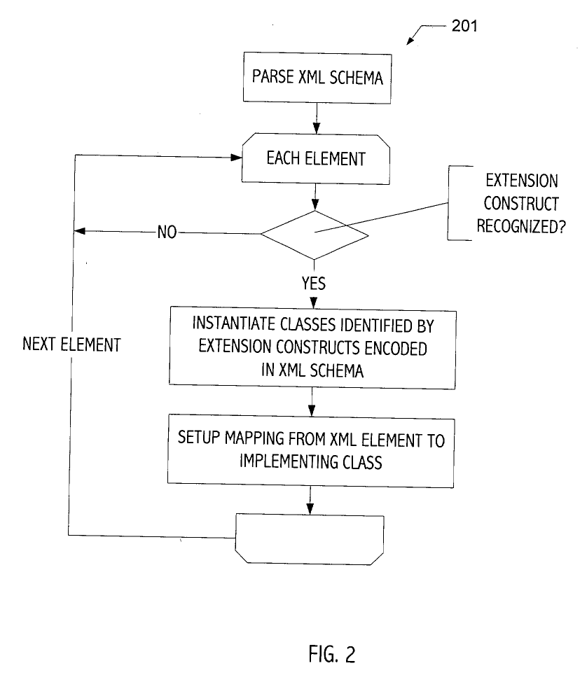

FIG. 2 summarizes some realizations in accordance with the above-described process. Depending on the constraints and/or design goals of a particular implementation environment, recognition of extension constructs, instantiation of corresponding classes and/or element-to-class mapping may be performed in the course of a given parse or as a post-process on parse results. Indeed, typical implementations may involve recursion rather than iteration. Nonetheless, flow 201 summarizes general behavior of a simplified extension construct recognition sequence. Variations, including other suitable sequences and integrations with parse state, will be appreciated based by persons of ordinary skill in the art.

Referring again to FIG. 1, XML processor 101b operates on XML encoded information 113. Typically, XML processor 101b parses XML encoded information 113 based on XML Schema 111 and builds an execution environment appropriate encoding thereof. In the illustrated configuration, one suitable execution environment appropriate encoding is as active DOM tree 121. As previously described, some realizations may exploit techniques of the present invention to provide scripting language support. For example, XML encoded information may include an appropriately encoded directive (e.g., fragment 113a) as follows:

<xxs:set ref=“employee.lastname” value=“Jones” />

building on the previously described XML schema extension, whereby class 112a was instantiated (as functionality 122) in execution environment 120 to correspond to nodes (e.g., node 123) of DOM tree 121. In such case, walking DOM tree 121 results in evaluation of node 123 which in turn invokes the corresponding instantiated class 122. In this way, any of a variety of actions, including modification of DOM tree 121 may be performed by the functionality of the instantiated class and the extension construct(s) described herein provide a convenient approach for defining, maintaining and/or customizing that functionality, all in an XML-based environment.

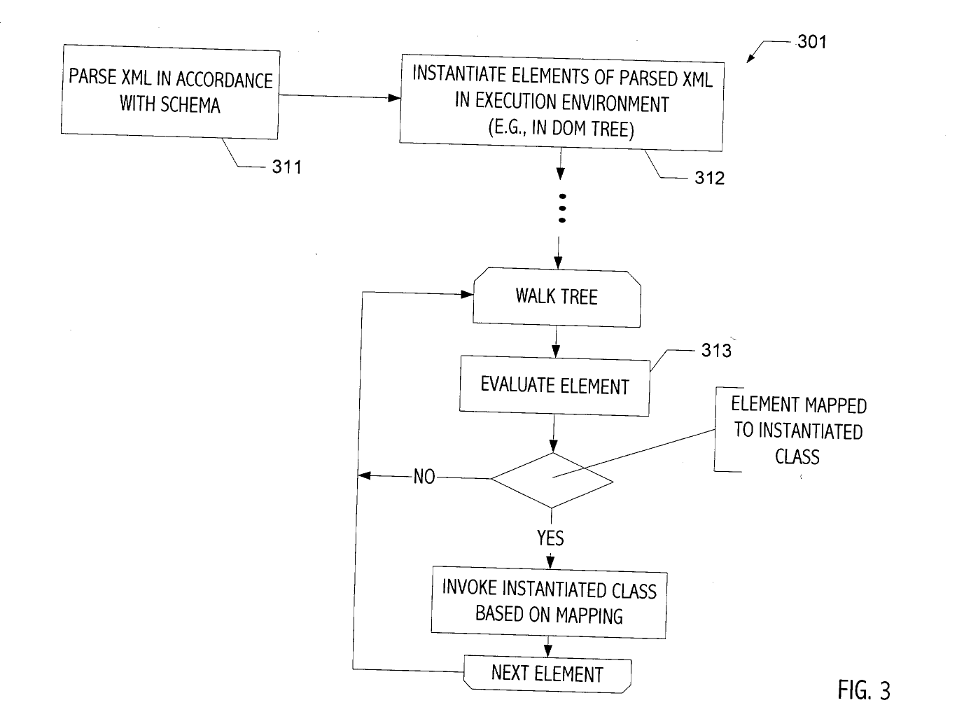

FIG. 3 summarizes some realizations in accordance with the above described process. An XML processor parses an XML encoding such as information 113 including fragment 113a, which includes an element (e.g., “set”) that has been associated with an instantiated class (e.g., Public Class Set). Typically, the parsing is based at least in part on XML Schema 111 and the class associated element is recognized accordingly. In the illustrated environment, elements of the parsed XML are instantiated as features (e.g., nodes) of DOM tree 121. Typically, DOM tree 121 is traversed at some point and individual elements thereof are evaluated (313). For simplicity, traversal of DOM tree 121 is illustrated as an iterative sequence, although persons of ordinary skill in the art will recognize that recursion may be employed instead. In any case, for those elements mapped to an instantiated class (as previously described), evaluation includes invocation of the mapped instantiated class. Using the above-described fragment as an example, evaluation of node 123 invokes instantiated class 122 with a first attribute, ref, of “employee.lastname” and a second attribute, value, of “Jones”. XML Schema 111 indicates that ref and value attributes are required and that the ref attribute is passed by reference.

As before, depending on the constraints and/or design goals of a particular implementation environment, recognition of extension constructs and/or class invocations may be performed in the course of a given parse or as a post-process on parse results. As mentioned, some implementations may involve recursion rather than iteration. Nonetheless, flow 301 summarizes general behavior of a simplified sequence that walks the parsed representation of XML. Variations, including other suitable sequences and integrations with parse state, will be appreciated based by persons of ordinary skill in the art.

### OTHER EMBODIMENTS

While the invention is described with reference to various implementations and exploitations, it will be understood that these embodiments are illustrative and that the scope of the invention(s) is not limited to them. Many variations, modifications, additions, and improvements are possible. For example, while XML encodings, SAX parser implementations and DOM terminology provide a useful descriptive context, exploitations of the present invention are not limited thereto. Indeed, other structured information encodings (including other markup language encodings), other structured information processors (be they parser based or otherwise) and other execution environment representations (tree-based, object-structured, standards-based or otherwise) are all contemplated. Similarly, although DOM techniques are particularly adept for managing the interface between XML and HTML representations of web content, the inventive concepts described herein are not limited thereto. Furthermore, while an <xxsd> tag-based, namespace-element (e.g., URI) identifying extension construct is described in detail, other extension constructs including those based on customized interpretations of content expressed within the span of an annotation (e.g., <xsd: annotation> . . . </xsd:annotation>) element are also possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. A method of supporting application specific functionality in an XML processing environment, the method comprising:
encoding in an XML schema, an extension construct that maps an element of the XML schema to a class that implements the element.

2. The method of claim 1, further comprising:
providing in conjunction with a parser, a mechanism to instantiate in the XML processing environment, the mapped class.

3. The method of claim 2,
wherein the parser recognizes, based on the XML schema, the extension construct.

4. The method of claim 1, further comprising:
parsing an XML directive that includes an instance of the-extension construct; and
evaluating the mapped class as part of processing a node of a parsed data structure that corresponds to the extension construct instance.

5. The method of claim 1, further comprising:
as part of processing an XML directive that contains an instance of the identifier, evaluating the mapped class.

6. The method of claim 1, further comprising:
generating a document object model representation; and
modifying the document object model representation based on evaluation of the mapped class.

7. The method of claim 1,
wherein the extension construct employs an attribute in a namespace of the XML schema.

8. The method of claim 1,
wherein the extension construct employs annotations of the XML schema.

9. A schema encoded in one or more computer readable media, the schema encoding comprising:
plural tagged markup language encoded elements,
wherein at least one of said tagged markup language encoded elements is extended by a mechanism that maps an element of the schema to a class that implements the element.

10. The encoded schema of claim 9,
wherein tagged markup language is in accordance with an XML syntax.

11. The encoded schema of claim 9,
wherein the extension construct employs an attribute in a namespace of the schema.

12. The encoded schema of claim 9,
wherein the extension construct employs schema annotations.

13. A tagged markup language processor that instantiates functionality in an execution environment based on a schema extended by a mechanism that maps an element of the schema to the functionality, the functionality implementing the element, and wherein the tagged markup language processor evaluates tagged markup language directives at least in part using the instantiated functionality.

14. The tagged markup language processor of claim 13,
wherein the tagged markup language is in accordance with an XML syntax.

15. The tagged markup language processor of claim 13, configured as an XML gateway.

16. A tagged markup language processor comprising:
a schema encoded in media readable by the tagged markup language processor; and
a parser that instantiates functionality in an execution environment based on elements of the schema, wherein the schema is extended by a mechanism that maps at least a particular element thereof to the functionality, and wherein the mapped functionality implements the particular element.

17. The tagged markup language processor of claim 16, further comprising:
a scripting interface whereby the tagged markup language processor receives a tagged markup language directive that includes a tag corresponding to the particular element and evaluates the functionality mapped thereto.

18. An apparatus comprising:
a means for encoding a schema extended by a mechanism that maps an element of the schema to functionality that implements the element; and
means for evaluating a directive based at least in part on the functionality.

19. The apparatus of claim 18, further comprising:
means for instantiating the functionality based on the schema.
